(19) United States
(12) Patent Application Publication
(10) Pub. No.: US 2020/0180993 A1
(43) Pub. Date: Jun. 11, 2020

(54) METHOD FOR FORMING A SERIES OF DEFECTS AT DIFFERENT DEPTHS IN A SHEET OF MATERIAL, SHEET OF MATERIAL AND ELECTRONIC DEVICE

(71) Applicant: INSTITUT NATIONAL D'OPTIQUE, Quebec (CA)

(72) Inventors: David GAY, Quebec City (CA); Louis DESBIENS, Quebec City (CA); Yves TAILLON, Quebec City (CA)

(21) Appl. No.: 16/213,188

(22) Filed: Dec. 7, 2018

(51) Int. Cl. C03B 33/02; B23K 26/08; B23K 26/53

(52) U.S. Cl. CPC C03B 33/0222; B23K 26/53; B23K 26/083

(57) ABSTRACT

There is described a method of forming defects inside a sheet of material by using a laser system. The material has a damage irradiance threshold and an optical transparency window. The method has the steps of: moving a focal spot of a pulsed laser beam relatively to said sheet such that said focal spot moves in back and forth sequences across a thickness of said sheet as the focal spot is moved along a plane of said sheet, while emitting laser pulses of said pulsed laser beam, said laser pulses having a wavelength within said optical transparency window and having an irradiance at said focal spot exceeding said damage irradiance threshold thereby forming a plurality of defects inside said sheet, the plurality of defects being distributed both along said plane and across said thickness of said sheet of material.

### FIELD

The technical field generally relates to laser processing of materials, and more particularly to methods for cutting a sheet using a pulsed laser beam, to the sheets cut using such methods, and to electronic devices comprising such sheets.

### BACKGROUND

Laser cutting generally involves using a laser beam to ablate a piece of material along a cutting line in order to cut it into parts. Although relevant in many applications, such laser cutting techniques generally result in material loss resulting from material ablation and ablated material deposits on the cut parts.

However, stealth dicing is a laser cutting technique in which the piece of material is locally weakened along a cutting line after which the piece can be separated at the cutting line by inducing a stress (e.g., mechanical, thermal) on the piece. More specifically, the local weakening is embodied in the form of defect lines superposed to one another at different depths inside the piece of material. Each defect line includes a plurality of spaced-apart defects which are obtained by locally modifying the structure of the material using a focused laser beam.

It is generally accepted in the field that the greater the number of defect lines is, the greater the quality of the cut. However, the quality of the cut is also dependent on a tolerance with which the defect lines are superposed to one another, which is increasingly challenging to reduce as the number of defect lines increases. Indeed, providing a number of defect lines which are satisfactorily aligned with one another, within a single cutting plane, generally requires high resolution translation stages which are costly and prone to misalignments over time. Moreover, providing a significant number of defect lines tends to be time consuming as each defect line requires its own pass of the focused laser beam.

Although existing stealth dicing techniques are satisfactory to a certain degree, there remains room for improvement.

### SUMMARY

There are described methods for forming defects inside a sheet of material extending in a plane and having a thickness. The defects are formed by moving a focal spot of a pulsed laser beam relatively to the sheet such that the focal spot is moved reciprocally, i.e. in back and forth sequences, across the thickness of the sheet while it is moved along the plane of the sheet, during which laser pulses of the pulsed laser beam are emitted. The laser pulses have an irradiance at the focal spot which is greater than a damage irradiance threshold of the material while having a wavelength which is in an optical transparency window of the material. Accordingly, the pulsed laser beam can propagate through the thickness of the sheet, and the laser pulses of the pulsed laser beam can form a defect inside the material at the focal spot due to nonlinear absorption.

When the defects are formed in a single pass of the pulsed laser beam, the so-formed defects can thus be distributed in a single defect line having an oscillatory path progressing back and forth across the thickness as the oscillatory path follows the plane. Such a single defect line can weaken the sheet of material enough that a cut of satisfactory quality can be obtained by inducing a stress (e.g., mechanical, thermal) to the sheet.

As can be appreciated, the sheet so cut exhibits an edge face having defects thereon. The defects can be distributed along an oscillatory path progressing back and forth across the thickness as the oscillatory path follows a length of the corresponding edge face.

Therefore, the methods described here can be conveniently performed to provide cuts of satisfactory quality even in materials of enhanced strength such as toughened glass or crystalline materials such as silicon wafers or sapphire wafers which are commonly used in electronic devices nowadays.

In accordance with one aspect, there is provided a method of forming defects inside a sheet of material with a laser system, the material having a damage irradiance threshold and an optical transparency window, the method comprising: moving a focal spot of a pulsed laser beam relatively to said sheet such that said focal spot moves in back and forth sequences across a thickness of said sheet as the focal spot is moved along a plane of said sheet, while emitting laser pulses of said pulsed laser beam, said laser pulses having a wavelength lying within said optical transparency window and having an irradiance at said focal spot exceeding said damage irradiance threshold thereby forming a plurality of defects inside said sheet, the plurality of defects being distributed both along said plane and across said thickness of said sheet of material.

In accordance with another aspect, there is provided a sheet of material comprising a sheet body having at least one edge face, the at least one edge face having a thickness orientation perpendicular to a plane of the sheet body and having a plurality of defects on the at least one edge face, the plurality of defects being distributed along an oscillatory path progressing back and forth across the thickness orientation as the oscillatory path follows a length of the at least one edge face.

In accordance with another aspect, there is provided an electronic device comprising a frame and a sheet of material mounted to the frame, the sheet of material comprising a sheet body having at least one edge face, the at least one edge face having a thickness orientation perpendicular to a plane of the sheet body and having a plurality of defects on the at least one edge face, the plurality of defects being distributed along an oscillatory path progressing back and forth across the thickness orientation as the oscillatory path follows a length of the at least one edge face.

In accordance with another aspect, there is provided a method of forming defects inside a sheet of material with a laser system, the material having a damage irradiance threshold and an optical transparency window, the method comprising a focal spot of the pulsed laser beam periodically scanning the thickness of the sheet of material as the point of incidence of the pulsed laser beam travels over the sheet of material incidence surface along a predefined path (hereinafter “cutting line”). The cutting line and the thickness of the sheet of material form a cutting plane containing a series of defects distributed in a pattern that oscillates in the thickness of the sheet of material.

It will be understood that the expression “sheet of material” as used herein is not to be interpreted in a limiting manner. It defines any shape of workpiece for which the thickness is smaller than both width and length of the workpiece.

Many further features and combinations thereof concerning the present improvements will appear to those skilled in the art following a reading of the instant disclosure.

### DESCRIPTION OF THE FIGURES

In the figures,

FIG. 1 is a front elevation view of an example of an electronic device comprising a sheet of material, in accordance with an embodiment;

FIG. 1A is a sectional view of an edge face of a sheet of material of the electronic device of FIG. 1, taken along line 1A-1A of FIG. 1;

FIG. 2 is a sectional view of an edge face of a sheet of material showing defects formed using one conventional stealth dicing technique, in accordance with the prior art;

FIG. 3 is a sectional view of an example sheet of material, taken across a thickness thereof, showing defects being formed by a back and forth movement of a focal spot of a pulsed laser beam as the sheet is moved along a plane thereof, showing defects being concentrated proximate to both opposite faces of the sheet, in accordance with an embodiment;

FIG. 4 is a sectional view of an example sheet of material, taken across a thickness thereof, showing a back and forth movement of a focal spot of a pulsed laser beam across the thickness of the sheet as it is moved along a plane of the sheet, forming equally spaced defects along the plane of the sheet, in accordance with an embodiment;

FIG. 5 is a sectional view of an example sheet of material, taken across a thickness thereof, showing defects being concentrated in a middle portion of the sheet, in accordance with an embodiment;

FIG. 6 is a sectional view of an example sheet of material, taken across a thickness thereof, showing a back and forth movement of a focal spot of a pulsed laser beam across the thickness of the sheet as it is moved along a plane of the sheet, during which some back and forth movements of the focal spot form no defects, in accordance with an embodiment;

FIG. 7 is a sectional view of an example sheet of material, taken across a thickness thereof, showing a back and forth movement of a focal spot of a pulsed laser beam across the thickness of the sheet as it is moved along a plane of the sheet, during which the focal spot is moved outside the thickness of the sheet, in accordance with an embodiment;

FIG. 8 is a sectional view of an example sheet of material, taken across a thickness thereof, showing a back and forth movement of a focal spot of a pulsed laser beam across the thickness of the sheet as it is moved at a variable speed along a plane of the sheet, in accordance with an embodiment; and

FIG. 9 shows a schematic view of an example of a system for laser forming defects in a sheet of material, in accordance with an embodiment.

### DETAILED DESCRIPTION

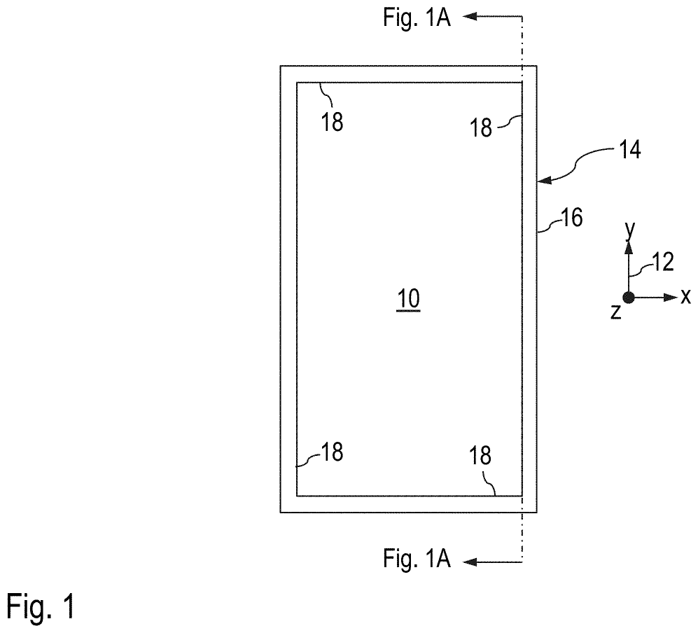

FIG. 1 shows an example of a sheet body 10 of material. The sheet body 10 can be provided in the form of a wafer, a slab or any other suitable sheet body. The sheet body 10 has a plane 12 oriented parallel to the x-y plane defined by the x- and y-axes, and a thickness oriented along the z-axis, perpendicular to the x-y plane.

As depicted, the sheet body 10 can be included in an electronic device 14 (e.g., a smartphone, a tablet, a remote control, a television, a computer display, etc.). In this specific example the electronic device 14 has a frame 16 to which is mounted the sheet body 10.

As will be understood, the material of the sheet body 10 is characterized by an optical transparency window having a spectral bandwidth Δλ, a damage irradiance threshold I_{d}, and in some cases, by a surface ablation irradiance threshold Iₐ. Accordingly, the material of the sheet body can be glass, and more specifically toughened glass such as Corning's Gorilla Glass™, Asahi Glass Co.'s Dragontrail™ and Schott AG's Xensation™. The optical transparency window of the material indicates the wavelengths A at which the material is transparent or semi-transparent.

In this example, the sheet body 10 has four edge faces 18. Each of the four edge faces 18 has a straight linear path in the x-y plane. However, in some other embodiments, the edge faces 18 of the sheet body 10 can have curvilinear paths or any other suitable type of paths in the x-y plane.

FIG. 1A shows a side view of one of the four edge faces 18 of the sheet body 10, taken along line 1A-1A of FIG. 1. As illustrated, the edge face 18 has a thickness Δz extending along the z-axis (also referred to as the thickness orientation) and perpendicular to the x-y plane of the sheet body 10.

The edge face 18 has a plurality of observable defects 20. More specifically, these defects 20 are distributed along an oscillatory path 22 progressing back and forth across the thickness Δz as the oscillatory path 22 follows a length Δy of the edge face 18 along the y-axis. In this embodiment, the oscillatory path 22 has a sinusoidal shape. However, the oscillatory path 22 can define a triangular shape or any other oscillatory shape in alternate embodiments. Accordingly, the resulting defects 20 are spaced from one another along the thickness Δz of the sheet body 10 as well as being spaced from one another along the length Δy of the edge face 18 of the sheet body 10.

As will be described in greater detail below, these defects 20 result from one of the methods described herein. More specifically, the method comprises moving a focal spot of a pulsed laser beam relatively to the sheet body 10 such that the focal spot moves in back and forth sequences (i.e. reciprocally) across the thickness Δz of the sheet body 10 as the focal spot is moved along the x-y plane of the sheet body 10, while laser pulses of said pulsed laser beam are emitted. Such moving of the focal spot relatively to the sheet body 10 causes the defects to be laser formed inside the sheet body 10 in a distribution 24 extending both along the x-y plane and across the thickness Δz of the sheet body 10 of material.

The laser pulses have a wavelength A that lies within the optical transparency window of the material in which defects are to be formed. Additionally, the laser pulses reach an irradiance I at the focal spot exceeding the damage irradiance threshold I_{d} of the material, i.e. I>I_{d}. The irradiance I can be expressed in units of W/m² in this embodiment. As can be understood, the irradiance of the laser pulses can be below the damage irradiance threshold I_{d} of the material elsewhere than at the focal spot, to avoid forming line-shaped defects extending along the thickness of the material. Accordingly, when the irradiance I of the laser pulses exceeds the damage irradiance threshold I_{d} of the material only at the focal spot, or in a vicinity thereof, defects having a dot-like shape can be satisfactorily formed.

In this case, the irradiance I of the laser pulses at the surface of the material does not exceed the surface ablation irradiance threshold Iₐ. In this way, the pulsed laser beam can propagate through the thickness Δz of the material without damaging the surface of the sheet. The high optical irradiance of the laser pulses in regions close to the focal spot can induce a nonlinear absorption effect within the material, which is at the origin of the defects created in the material. For instance, far from the focal spot, the irradiance of the pulsed laser beam is below the damage irradiance threshold I_{d} of the bulk and of the surface ablation threshold Iₐ of the material, so that the laser pulses undergo negligible nonlinear absorption, allowing the laser beam to propagate up to the focal spot without suffering from sizeable energy loss. Indeed, it may be preferable to provide a weak linear absorption across the thickness of the material to allow similar nonlinear absorption levels at different depths in the material. Also, it may be preferable to provide laser pulses with very short pulse durations in order to avoid creating large defects due to absorption of high-energy pulses.

As can be understood, during the defect forming, the sheet body 10 is provided with at least one face 26 having an optical quality high enough to avoid excessive degradation of the pulsed laser beam as it passes through the face 26 of the sheet body 10. The defects 20 so formed can be considered as localized modifications of the internal structure of the material created by nonlinear absorption of the energy of a laser pulse or a plurality of laser pulses. The modifications can be in the form of a crack or a change in the molecular structure which has the consequence of locally weakening the material.

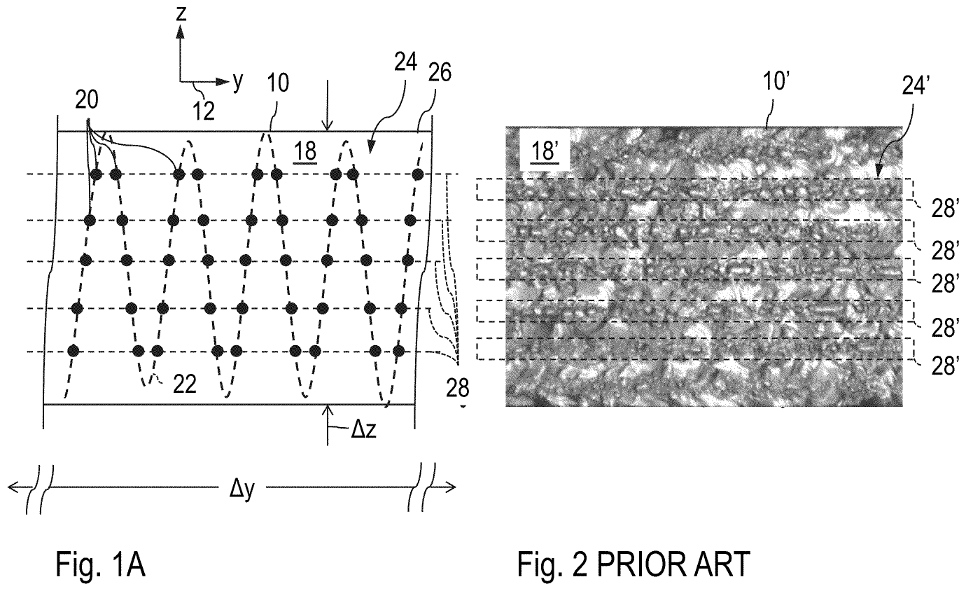

As will be understood, the distribution 24 of defects 20 on the edge face 18 of the sheet body 10 is indicative of an edge face 18 of the sheet body 10 that has been previously separated from a larger sheet of material using the method described herein instead of a conventional stealth dicing technique which generally results in a distribution 24′ of defects as the one shown in FIG. 2.

Indeed, the edge face 18′ of FIG. 2 shows a plurality of defect lines superposed to one another, shown in dashed boxes 28′, indicating that successive passes of a pulsed laser beam were required to weaken the sheet 10′ of material prior to inducing the stress. Accordingly, the distribution 24′ of defects formed on the edge face 18′ of FIG. 2 does not show an oscillatory path. In addition, FIG. 2 shows that the defects are nearly equally spaced along each defect lines 28′ of the sheet body 10′.

Returning to FIG. 1A, the defects 20 so-formed can define virtual defect lines 28 mimicking the defect lines of the edge face 18′ of FIG. 2, and thus can allow cuts of similar or higher quality, without necessarily requiring several passes of the pulsed laser beam. It is contemplated that the defects 20 so-formed do not necessarily define such virtual defect lines 28 while still providing effective weakening of the material.

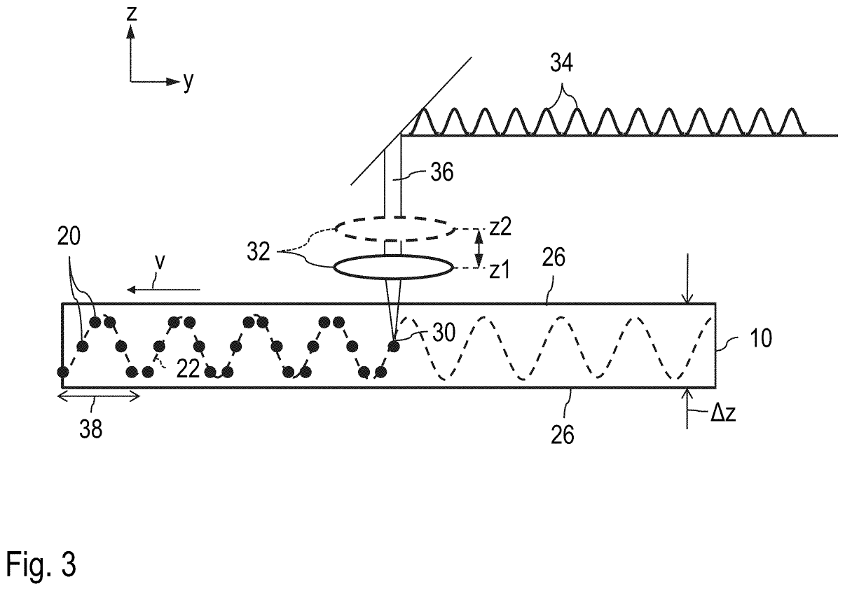

One example of movement of the focal spot 30 relative to the sheet 10 is described with reference to FIG. 3. As shown, in this example, the sheet 10 is moved in the x-y plane, and more specifically along the y-axis, while the focal spot 30 is moved reciprocally across the thickness Δz of the sheet 10. In this context, the reciprocal movement of the focal spot 30 can resemble that of a sequence of back and forth of the focal spot 30 across the thickness Δz of the sheet along the z-axis.

In this specific embodiment, the reciprocal movement of the focal spot 30 is obtained by oscillating the position of a focusing lens assembly 32 having a fixed focal length along the thickness orientation Δz while the sheet 10 is moved in the x-y plane. As shown, the position of the focusing lens assembly 32 is oscillated between positions z1 and z2 in this example. As such, the focal spot 30 is oscillated along the thickness orientation Δz at a given oscillation frequency fₒ.

As can be understood, the relative difference between the oscillation frequency fₒ of the focal spot 30 and the rate at which the laser pulses are emitted, i.e. the pulse repetition rate f₁, has an impact on the resulting distribution of defects 20 created in the sheet 10.

For instance, in the embodiment shown in FIG. 3, the repetition rate fᵣ of the laser pulses 34 exceeds the oscillation frequency fₒ. Accordingly, at least some defects 20 are formed in the sheet 10 in a single oscillation of the focal spot 30. In other words, each cycle 38 of the oscillatory path 22 has a plurality of defects 20 formed therealong.

As may be appreciated, when the sheet 10 is moved along the y axis of the x-y plane at a constant speed v and when the pulse repetition rate fᵣ is constant, such as in this embodiment, the defects 20 so-formed can be concentrated proximate to opposite faces 26 of the sheet 10. Such a distribution of defects 20 can help in achieving cuts of satisfactory quality as surface kerfs are less likely to occur when there are more defects 20 proximate the faces 26.

In this specific embodiment, the energy of the laser pulses 34 is selected such that the irradiance I at the focal spot is above the damage irradiance threshold I_{d} of the material in which defects are to be formed. As can be understood, the irradiance I at the surface of the sheet of material needs to be lower than the surface ablation irradiance threshold Iₐ to form satisfactory defects 20 in the sheet 10 of material. Accordingly, the energy of the laser pulses can be tuned such that the irradiance I at the focal spot is slightly above the damage irradiance threshold I_{d} which thus allows high throughput with relatively low-power laser sources. It is contemplated that laser pulses 34 having an irradiance I just above the damage irradiance threshold I_{d} near the focal spot can result in the formation of defects 20 having sizes in the micrometer scale, allowing the production of well-defined edge faces.

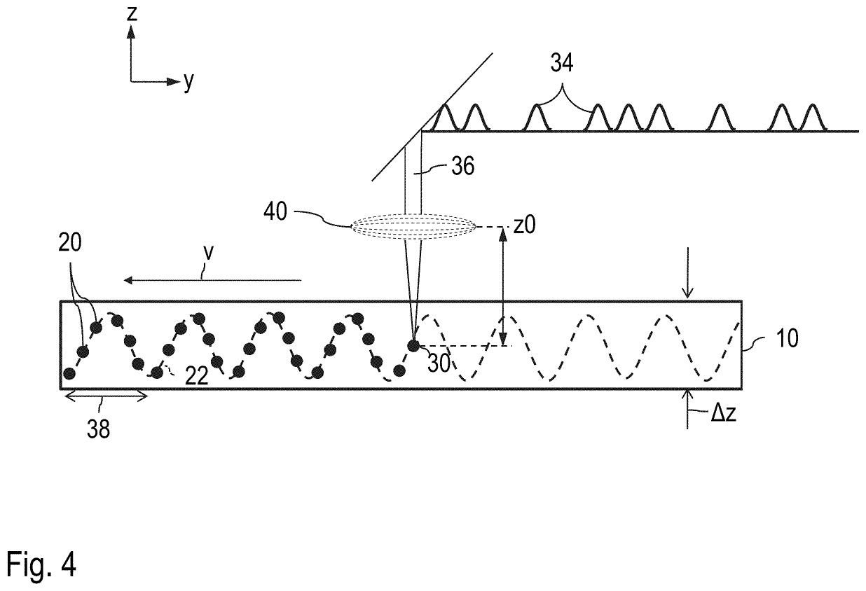

Another example of movement of the focal spot 30 relative to the sheet 10 is described with reference to FIG. 4. As shown, in this example, the sheet 10 is moved along the y-axis while the focal spot 30 is moved reciprocally across the thickness Δz of the sheet 10.

In this illustrated embodiment, the reciprocal movement of the focal spot 30 is obtained by varying the focal length of a variable focal lens assembly 40. More specifically, in this embodiment, the position of the variable focal lens assembly 40 is fixed while its variable focal length is oscillated as the sheet 10 is moved in the x-y plane.

Also shown in this embodiment, the laser pulses 34 have an instantaneous time-varying pulse repetition rate fᵣ(t), thus yielding an effective pulse repetition rate f_{r,eff}. As shown, the sheet 10 is moved at a constant speed v along the y-axis and the effective pulse repetition rate f_{r,eff} exceeds the oscillation frequency fₒ of the focal spot 30. As such, one can observe more than one defect 20 at each cycle 38 of the oscillatory path 22. The instantaneous pulse repetition rate fᵣ(t) of the laser pulses 34 is varied periodically in this example so as to form defects 20 being evenly spaced from one another in the y-z plane, which can be convenient in some applications.

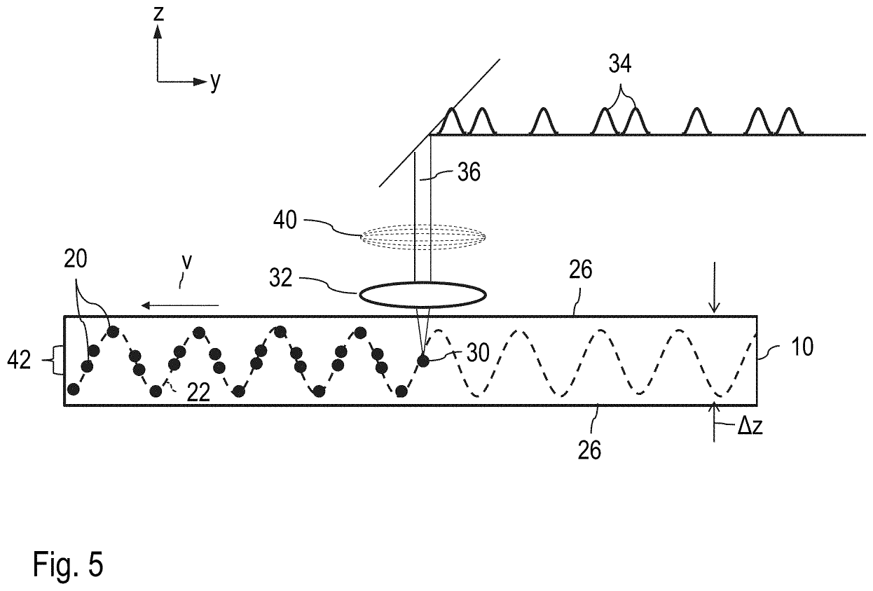

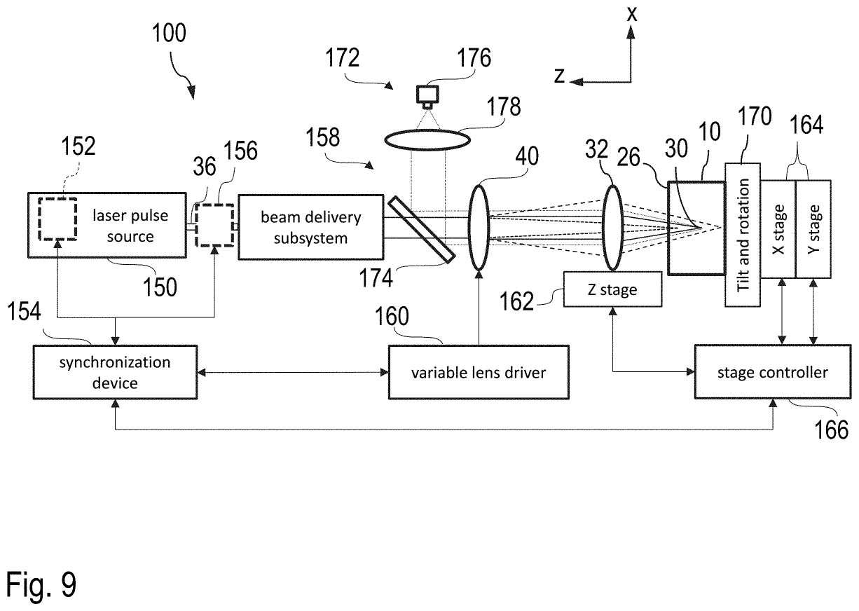

Another example of movement of the focal spot 30 relative to the sheet 10 is described with reference to FIG. 5. In this example, the reciprocal movement of the focal spot 30 is obtained by using a focusing lens assembly 32 which position along the z-axis can be oscillated as well as a variable focal lens assembly 40 which variable focal length can be oscillated. As such, the oscillation of the position of the focusing lens assembly 32 in addition to the variation of the focal length of the variable focal lens assembly 40 can be advantageously used to provide a greater range of reciprocal movement and/or more spatial precision. An example of which is also described below with reference to FIG. 9.

In some embodiments, the position of the focusing lens assembly 32 can be moved to compensate for imperfections in the planarity of the sheet 10. In these embodiments, the position of the focusing lens assembly 32 can be oscillated such that the focal spot 30 remains inside the thickness of the sheet 10 preferably at all times.

Moreover, in this example, the instantaneous repetition rate fᵣ(t) of the laser pulses 34 is varied so as to form defects 20 being more concentrated in a middle portion 42 of the sheet 10 than proximate the opposite faces 26 of the sheet 10. It can be understood that the instantaneous repetition rate fᵣ(t) of the laser pulses 34 used to form such a distribution of defects 20 differs from the instantaneous pulse repetition rate fᵣ(t) of the laser pulses 34 used to form the equidistant defects shown in FIG. 4.

In this embodiment, the oscillation frequency fₒ of the focal spot 30 is shown to be constant. However, in some embodiments, the oscillation frequency fₒ may be time-varying as well, which can in turn form defects along an oscillatory path having a varying period or frequency, instead of the constant oscillation frequency fₒ shown in FIG. 5.

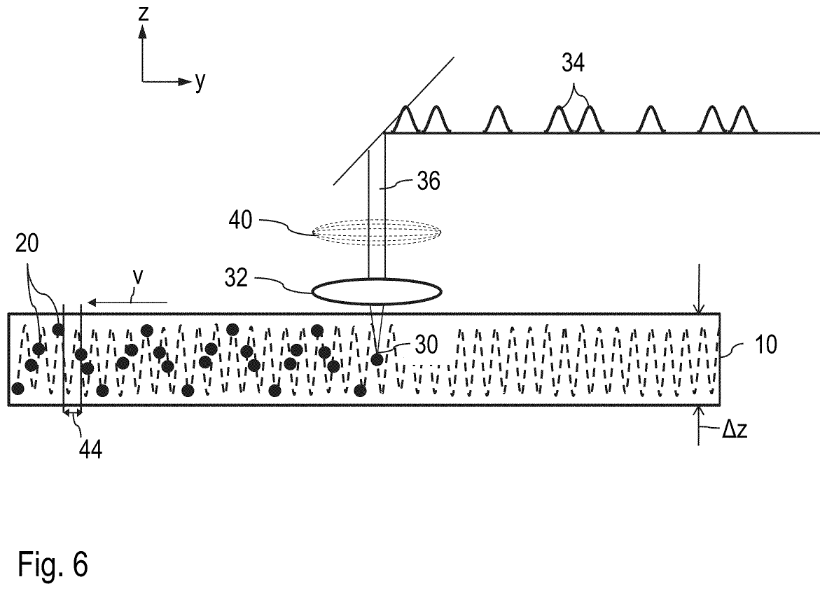

Another example of movement of the focal spot 30 relative to the sheet 10 is described with reference to FIG. 6. As shown, in this example, the sheet 10 is moved along the y-axis while the position of the focal spot is oscillated reciprocally along the thickness orientation Δz of the sheet 10 using the focusing lens assembly 32 and the variable focal lens assembly 40.

More specifically, in this illustrated embodiment, the oscillation frequency fₒ of the focal spot 30 exceeds the effective repetition rate f_{r,eff} of the laser pulses 34. As a result, there may be one or more intermediate oscillations of the focal spot 30 where no laser pulse is emitted towards the sheet 10, thus leaving one or more intermediate cycles, such as intermediate cycle 44, being free from any defect 20.

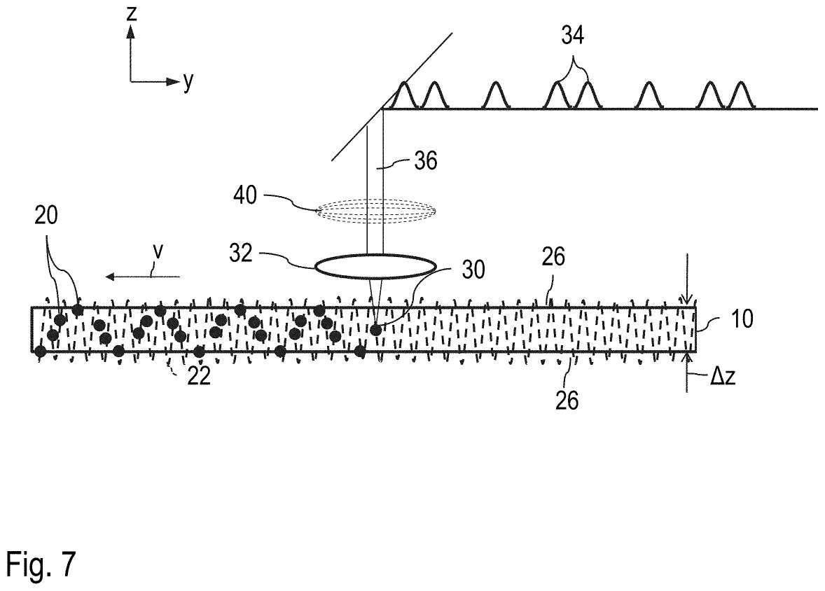

Another example of movement of the focal spot 30 relative to the sheet 10 is described with reference to FIG. 7. As shown, in this example, the sheet 10 is moved along the y-axis while the position of the focal spot 30 is oscillated reciprocally along the thickness orientation Δz of the sheet 10 using the focusing lens assembly 32 and the variable focal lens assembly 40.

More specifically, in this example, the focal spot 30 is oscillated across the thickness Δz of the sheet 10 such that the amplitude of the oscillatory path 22 exceeds the actual thickness Δz of the sheet 10. In this way, some laser pulses 34 can be emitted and focused outside the sheet 10, which obviously yield no defect. In such an embodiment, the resulting edge face can have an oscillatory path 22 which extrema can be observed to be truncated. Indeed, forming defects very close to the surfaces 26 can facilitate the separation of the parts thereafter.

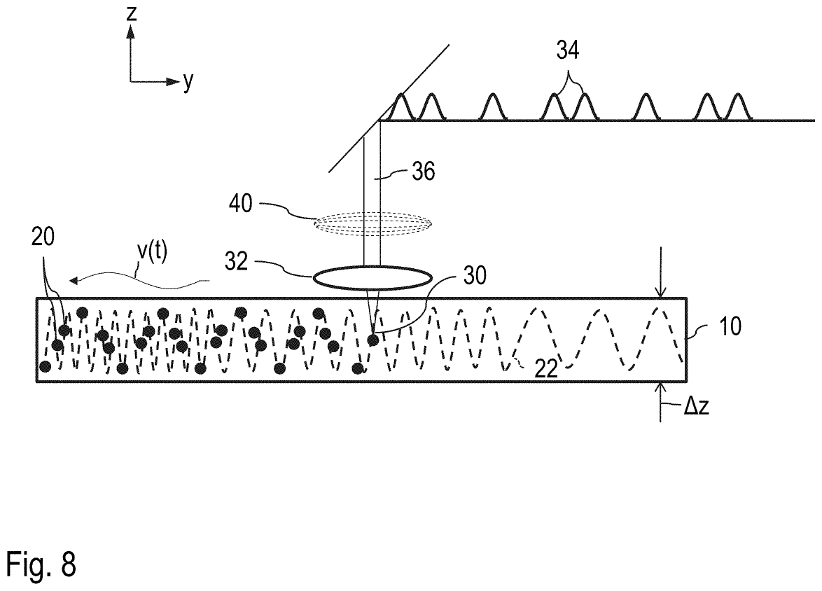

Another example of movement of the focal spot 30 relative to the sheet 10 is described with reference to FIG. 8. As shown, in this example, the sheet 10 is moved along the y-axis at an adjustable speed v(t) while the position of the focal spot 30 is oscillated reciprocally along the thickness orientation Δz of the sheet using the focusing lens assembly 32 and the variable focal lens assembly 40.

As can be understood, the resulting distribution of defects 20 can be distributed along an oscillatory path 22 having a varying period T(t) or frequency f(t). Accordingly, the speed at which the sheet 10 is moved can either be constant or variable, depending on the embodiment.

FIG. 9 shows an example of a laser system 100 for forming defects in a sheet 10 of material. As can be understood, the system 100 described below can allow forming a distribution of defects in the sheet 10 of material in a way which can require only one pass of the pulsed laser beam 36 along an arbitrary path in the x-y plane to weaken the sheet 10 of material similarly to as in conventional stealth dicing techniques. However, as only one pass of the pulsed laser beam 36 can be required to form defects at different depths along an oscillatory path inside the sheet 10, the system 100 can be exempt of high-precision motion systems (i.e., systems providing spatial resolutions of about 5 μm or less) which are generally required with conventional stealth dicing techniques. Rather, the system 100 can make use of lower precision motion systems and still be able to satisfactorily form defects inside the sheet 10 to weaken it along the oscillatory path.

As depicted, the system 100 has a source 150 of laser pulses. In this specific embodiment, the source 150 of laser pulses is provided in the form of a fiber laser. The laser pulses generated by the source 150 have a wavelength A in the range of about 500 to 1600 nm, an optical energy per pulse of about 1 to 100 ρJ, a duration of about 1 to 50 ps, and a repetition rate fᵣ ranging from single shot up to tens of MHz.

However, it will be understood that in other embodiments, the wavelength λ of the laser pulses can range from about 190 nm to about 11 μm. The optical energy per laser pulse can range from about 1 nJ to about 1 mJ. The duration of the laser pulses can range from about 100 fs to about 1 μs. The laser pulses may be provided by a Q-switch laser, a mode-locked laser or through direct modulation of the laser gain or any combination of these schemes. The laser pulses can be further amplified in a chain of optical amplifiers (MOPA configuration) depending on the pulse energy level required for a particular process. The laser gain medium can be a suitably doped optical fiber, a solid-state medium, or a semiconductor medium.

In this embodiment, the system 100 has a laser pulse control device 152 which can be used to generate only the laser pulses required to generate the defects. In this example, the laser pulse control device 152 is part of the source 150 of laser pulses. In this embodiment, the time sequence of the laser pulse emission can be determined by an external triggering source which can be part of a synchronization device 154. However, in some other embodiments, the laser pulse control device 152 can be used to select only the laser pulses exiting at an optical exit port 156 of the source 150 of laser pulses which are needed to generate the defects from a train of laser pulses generated at a given constant repetition rate f₁. In this embodiment, the time sequence of the pulse emission to be selected can be determined by an external triggering source which can be part of the synchronization device 154. The laser pulses are emitted and/or selected at a repetition rate fᵣ from single shot to tens of MHz. In these embodiments, the laser pulse control device 152 can provide laser pulses with predictable latency and minimal jitter.

As illustrated, the system 100 has a beam delivery system 158. In this embodiment, the beam delivery system 158 has a series of optical components to shape the spatial profile of the pulsed laser beam 36 to meet predetermined requirements (e.g., beam diameter, beam divergence, beam polarization) and to adjust the energy per pulse, thus the irradiance at the focal spot, dictated by the combination of lenses that generates the focal spot 30 of the pulsed laser beam 36 and the forming of the defects.

More specifically, the beam delivery system 158 has a variable focal lens assembly 40. As can be understood, the focal length of the variable focal lens assembly 40 can be oscillated between infinity and about 0.1 meters (converging, diverging or both). The sweep frequency of the focal length can be set at a value ranging from about 10 Hz to about 1 MHz. The drive signal is provided by a driver 160 that can communicate the phase of the drive signal in real-time or quasi real-time. The optical transmission of the variable focal lens assembly 40 is greater than about 50% at the wavelength of the laser pulses in this embodiment. An example of the variable focal lens assembly 40 can include a tunable high-speed acousto-optic lens such as the lens HP manufactured by Tag Optics Inc. (Princeton, N.J.). Alternately, the variable focal lens assembly 40 can include tunable acoustic gradient index lenses, liquid lenses and KTN lenses combined with a drive signal source.

The beam delivery system 158 also includes a focusing lens assembly 32. The focusing lens assembly 32 has a focal length which is short enough and has characteristics which cause few aberrations to be generated. The size of the focal spot 30 (i.e. beam waist) is near the diffraction limit at the working wavelength A. It can vary from about 0.25 μm to about 20 μm in some embodiments.

The focal length of the focusing lens assembly 32 is chosen in accordance with the focal length of the variable focal lens assembly 40 in order to obtain a range of effective focal lengths that is in the range of to the thickness Δz of the sheet 10 of material in which defects are to be laser formed. By using such a combination, defects can be formed in sheet 10 of material having a thickness Δz ranging from about tens of μm to about at least some mm. In some embodiments, the maximum displacement of the focal spot in the z-axis can range from about 50% to about 150% of the thickness Δz of the sheet 10 of material where defects are to be formed in the volume of the sheet 10 of material.

As shown in this embodiment, the focusing lens assembly 32 is mounted on a motion stage 162 that moves the focusing lens assembly 32 parallel to a propagation axis of the pulsed laser beam 36 in order to adjust the position of the focal spot 30 of the pulsed laser beam 36 inside the sheet 10 of material.

The illustrated system 100 has a multi-axis motion subsystem 164. In this example, the multi-axis motion subsystem 164 has at least two axes of motion, e.g., the x-axis and the y-axis, which are perpendicular to the propagation axis which extends along the z-axis. The translation speed along the x-axis and the y-axis can range from about 1 mm/s to about 1 m/s. The positioning accuracy along each of these two axes can be at least equal to the size of the defects to be formed in the sheet 10 of material. In this embodiment, the multi-axis motion subsystem 164 has a controller 166 which can communicate the position of the sheet 10 of material in real-time or quasi real-time.

The maximum speed at which the sheet 10 is moved depends on the mass to be moved and a curvature of the oscillatory path to be formed in the x-y plane. In order to keep constant the number of laser pulse shots per unit length, the repetition rate fᵣ of the laser source 150 can be synchronized and proportional to the speed of movement of the sheet of material in some embodiments.

As can be understood, the throughput of the dot-like defects forming by laser pulses as described herein can be greatly increased by the use of a fast variable focal lens assembly coupled with a high repetition rate source of ultrashort laser pulses. The capability of the laser source 150 to produce laser pulses on demand allows to form defects in curved lines in the x-y plane and to reduce downtime by pursuing the laser forming of defects during the accelerations and the decelerations of the sheet 10 of material as moved using the multi-axis motion subsystem 164.

The system 100 can include a tilt and rotation platform 170. As can be understood, the exposed one 26 of the opposite faces of the sheet 10 can be adjusted using tilt and/or roll adjustments so that the exposed face be parallel to the movement along the x-axis and along the y-axis.

The system 100 can have a vision system 172 having a dichroic mirror 174 and a camera 176. The vision system 172 can generate images in the x-y plane of the sheet 10 focused at different positions along the z-axis showing, for example, a portion of the surface 26 of the sheet of material or the defects 20 generated by the laser process in the volume of the material. The camera 176 is optically coupled to an objective lens assembly 178 having a focal length that enables the observation through the focusing lens assembly 32 and the variable focal lens assembly 40 of the exposed face 26 of the sheet 10, and more specifically of the defects formed therein.

As may be appreciated, the sequence of laser pulses, the state of the drive signal (e.g., the phase of the periodic drive signal) on the variable focal lens assembly 40, and the position of the sheet 10 can be either controlled, read, or both by the synchronization device 154 in order to form the defects at the desired locations with the desired distribution into the sheet 10 of material. The synchronization device 154 can be a dedicated apparatus and/or a software code that controls the other apparatuses. For example, the multi-axis motion subsystem 164 may indicate its position to a software which sends commands to the source 150 for the emission of the laser pulses according to the state of the variable focal lens assembly 40.

An example method for laser forming defects in a sheet of material can have a plurality of steps, some of which being optional. For instance, the sheet 10 of material can be installed on the multi-axis motion subsystem 164. Then, using the vision system 172, the position of the sheet 10 of material (e.g., along the z-axis) relative to the focal spot 30 of the pulsed laser beam 36 can be determined. The amplitude of the signal that drives the variable focal lens assembly 40 can be adjusted as a function of the thickness Δz of the sheet 10 of material. The frequency of the drive signal can also be adjusted as a function of the speed at which the sheet 10 of material is to be moved. Then, a desired distribution of defects can be selected, e.g., according to the type of material in which defects are to be formed. The repetition rate fᵣ (e.g., the instantaneous repetition rate fᵣ(t)) can be selected as function of the desired distribution of defects to be formed and as function of the speed at which the sheet 10 of material is to be moved. The emission of the laser pulses can be enslaved with the movement of the sheet 10 of material. The initial state of the phase of the drive signal can be acquired. The movement of the sheet 10 of material can be initiated, during which the emission of the laser pulses can be also initiated. If necessary, after the distribution of defects has been satisfactorily formed, a stress (e.g., mechanical, thermal) can be induced on the sheet 10 of material such that the sheet 10 of material be cut along a cutting line defined by the so-formed defects.

As can be understood, the examples described above and illustrated are intended to be exemplary only. For instance, in some embodiments, the movement of the focal spot of the pulsed laser beam relative to the sheet of material is obtained by moving the sheet both along the x-y plane and reciprocally across the thickness of the sheet while the focal spot is maintained at a fixed position. Alternately, the movement of the focal spot of the pulsed laser beam relative to the sheet of material is obtained by moving the focal spot both along the x-y plane and reciprocally across the thickness of the sheet while the sheet is maintained at a fixed position. It will be understood that the material of the sheet to be laser processed can be any material having an optical transparency window and a damage irradiance threshold. Additional examples of such materials include fused silica, sapphire, silicon, to name a few examples. The scope is indicated by the appended claims.

1. A method of forming defects inside a sheet of material with a laser system, the material having a damage irradiance threshold and an optical transparency window, the method comprising:
moving a focal spot of a pulsed laser beam relatively to said sheet such that said focal spot moves in back and forth sequences across a thickness of said sheet as the focal spot is moved along a plane of said sheet, while emitting laser pulses of said pulsed laser beam, said laser pulses having a wavelength lying within said optical transparency window and having an irradiance at said focal spot exceeding said damage irradiance threshold thereby forming a plurality of defects inside said sheet, the plurality of defects being distributed both along said plane and across said thickness of said sheet of material.

2. The method of claim 1 wherein said moving comprises moving said sheet along said plane at a given speed.

3. The method of claim 2 wherein said moving comprises, while moving said sheet along said plane, moving said focal spot in back and forth sequences across said thickness.

4. The method of claim 2 wherein said moving said sheet along said plane comprises adjusting said given speed during said moving.

5. The method of claim 1 wherein said moving said focal spot in back and forth sequences across said thickness comprises oscillating a position of said focal spot at a given oscillation frequency.

6. The method of claim 5 wherein said emitting said laser pulses is performed at a repetition rate exceeding said oscillation frequency, yielding more than one of said plurality of defects being formed in said sheet in a single oscillation of said position of said focal spot.

7. The method of claim 1 wherein said irradiance at said focal spot of said laser pulses exceeds said damage irradiance threshold while the irradiance of said laser pulses at a surface of the said material being below a surface ablation irradiance threshold of said material.

8. The method of claim 1 wherein said moving and said emitting is performed in a manner resulting in at least some defects of said plurality of defects being concentrated proximate to opposite faces of said sheet.

9. The method of claim 1 wherein said moving and said emitting is performed in a manner resulting in at least some defects of said plurality of defects being concentrated in a middle portion of said thickness of said sheet.

10-15. (canceled)
